(19) United States
(12) Patent Application Publication
(10) Pub. No.: US 2014/0057195 A1
(43) Pub. Date: Feb. 27, 2014

(54) Device of Charging/Discharging Electricity by Using Two Flows

(71) Applicant: Atomic Energy Council-Institute of Nuclear Research, (US)

(72) Inventors: Hwei-Liang Chang, Taoyuan County (TW); Zone-Sure Chang, Taipei City (TW)

(73) Assignee: Atomic Energy Council-Institute of Nuclear Research, Taoyuan County (TW)

(21) Appl. No.: 13/756,700

(22) Filed: Feb. 1, 2013

(30) Foreign Application Priority Data
Aug. 23, 2012 (TW) 101130727

(51) Int. Cl. H01M 8/20; H01M 8/18

(52) U.S. Cl. CPC H01M 8/20; H01M 8/188
USPC 429/508

(57) ABSTRACT

A device is provided for charging/discharging electricity. The device uses two flows. A first and a second solution are directed into liquid channels and ion exchange columns. Redox reactions are thus processed at conductive channels inside and outside of the ion exchange columns. The device can be used as a secondary battery with a simple structure, a light weight, an increased volume per unit, an enhanced charging/discharging power per unit and a saved production cost.

### TECHNICAL FIELD OF THE INVENTION

The present invention relates to a device for charging/discharging electricity; more particularly, relates to, instead of electrode ditches, using ion exchange columns and conductive channels as liquid channels for an electricity-charging/discharging device.

### DESCRIPTION OF THE RELATED ART

A general liquid cell usually comprises a shell, a pair of input/output terminals at an end of the shell, another pair of input/output terminals at another end of the shell and a plurality of electrode plates or dual-plates, where the electrode plates or dual-plates are set in the shell and are clipped with ion exchange membranes; and the electrode plates or dual-plates are electrode ditches. A working solution is directed from the input/output terminals at an end and flown out from the input/output terminals at another end. The working solution flows through liquid channels of the electrode plates or dual-plates for processing half-cell reactions in positive electrode and in negative electrode. Between the two half cells is a plane-shaped ion-exchange membrane to provide ion conduction. Thus, electricity is charged.

However, the general liquid cell has a complex structure and is heavy owing to using the plates or dual-plates of electrode ditches. As a result, its weight-power density is lowered and its production cost is increased. Moreover, its volume-power density can not be enhanced because the area for placing the ion exchange membranes in a unit of volume is limited. Therein, discharging capacity is also thus affected.

Hence, the prior art does not fulfill all users' requests on actual use.

### SUMMARY OF THE INVENTION

The main purpose of the present invention is to use inner and outer spaces of ion exchange columns for form liquid channels to be directed with a first and a second solutions for processing redox reactions of charging/discharging electricity to form a secondary battery with a simple structure, a light weight, an increased volume per unit, an enhanced charging/discharging power per unit and a saved production cost.

To achieve the above purpose, the present invention is a device of charging/discharging electricity by using two flows, comprising a container and an ion-exchange conductive channel unit, where the container has four openings at outside to be connected into the container inside; the four openings comprises a first; a second; a third and a fourth openings; the container has two separators to separate the third opening and the fourth opening; the container obtains two flows, one is connecting to the first and the second openings by using the separators, the other is connecting to the third and the fourth openings through the inside of the ion-exchange column of the ion-exchange conductive channel unit; the ion-exchange conductive channel unit is formed in the container to be connected with the third opening and the fourth opening while penetrating through the separators; the ion-exchange conductive channel unit comprises a plurality of ion exchange columns, a plurality of inner conductive channels and a plurality of outer conductive channels; the inner conductive channels are formed in the inside of the ion exchange columns; the outer conductive channels are formed at outside of the ion exchange columns without penetrating through the separators; and the inner conductive channels and the outer conductive channels come together to be extended out of the container to form a first electrode and a second electrode; respectively. Accordingly, a novel device of charging/discharging electricity by using two flows is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the perspective view showing the preferred embodiment according to the present invention; and

FIG. 2 is the sectional view showing the preferred embodiment.

### DESCRIPTION OF THE PREFERRED EMBODIMENT

The following description of the preferred embodiment is provided to understand the features and the structures of the present invention.

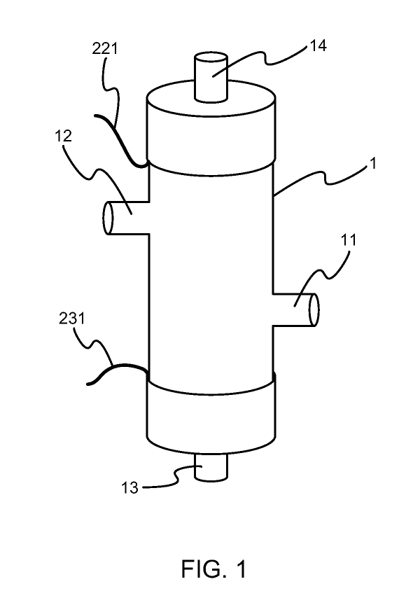

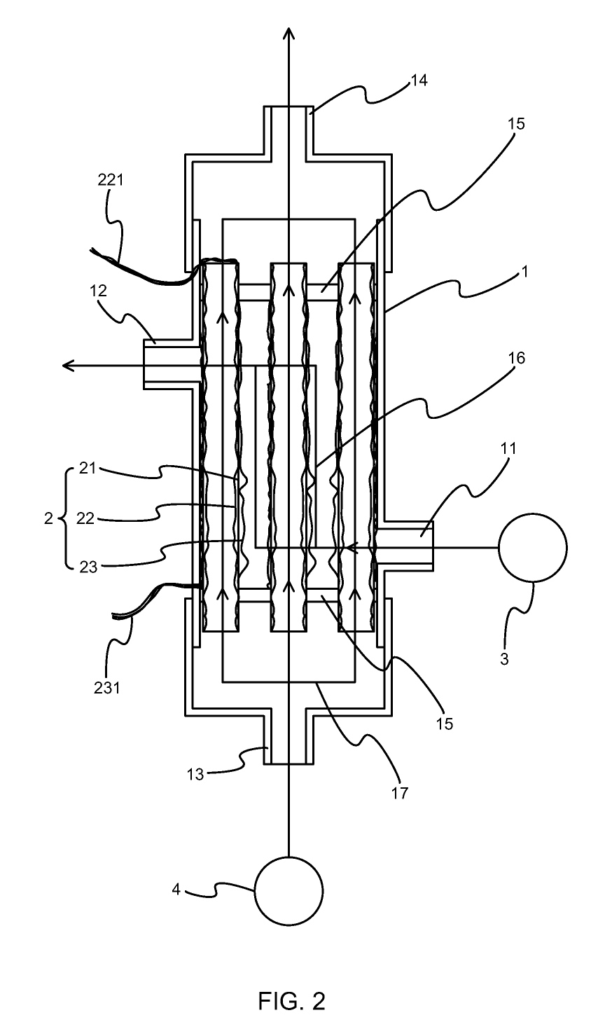

Please refer to FIG. 1 and FIG. 2, which are a perspective view and a sectional view showing the preferred embodiment according to the present invention. As shown in the figures, the present invention is a device of charging/discharging electricity by using two flows, comprising a container 1 and an ion-exchange conductive channel unit 2.

The container 1 has a first, a second, a third and a fourth openings 11,12,13,14 at outside; the container 1 has at least two separators 15 to separate the third and the fourth openings 13,14; and, thus, a first solution channel 16 is formed to connect to the first and the second openings 11,12. Therein, the container 1 has a geometric shape, like a tube shape, a box shape or a polygonal shape.

The ion-exchange conductive channel unit 2 is set in the container 1 and comprises a plurality of ion exchange columns 21, a plurality of inner conductive channels 22 and a plurality of outer conductive channels 23, where the inner conductive channels 22 are set in the ion exchange columns 21 and the outer conductive channels 23 are set at outside of the ion exchange columns 21. The ion exchange columns 21 and the inner conductive channels 22 penetrate through the separators 15; but the outer conductive channels 23 do not penetrate through the separators 15. The inner and outer conductive channels 22,23 come together to be extended out of the container 1 for forming a first and a second electrodes 221,231, respectively. Therein, any of the inner conductive channels 22 is not contacted with any of the outer conductive channels 23 for preventing shortcut. The inner and outer conductive channels 22,23 are made of carbon fiber (or conductive carbon porous tube), graphite fiber (or conductive graphite porous tube), metal fiber (or metal porous tube) or a conductive fiber bound with other non-conductive material(s). Although the inner and outer conductive channels 22,23 can be short of catalyst function, they must be conductive. Hence, the inner and outer conductive channels 22,23 can be conductive braided tubes or conductive porous tubes. The ion exchange columns 21 are cation exchange columns or anion exchange columns. The first electrode 221 is a negative electrode (or a positive electrode) and the second electrode 231 is a positive electrode (or a negative electrode). The two flows in the inner and outer conductive channels 22,23 are two solutions mutually processing electrochemical half-cell redox reactions; and, the two solutions contains metal ions, like vanadium (V) ions, chromium (Cr) ions, iron (Fe) ions, manganese (Mn) ions, cobalt (Co) ions or nickel (Ni) ions.

Thus, a novel device of charging/discharging electricity by using two flows is obtained.

On using the present invention, a first solution 3 (e.g. a VOSO₄ solution having V⁴⁺ or V⁵⁺ ions) is filled into the container 1 from the first opening 11. Then, the first solution 3 is directed into the first solution channels 16 to be coordinated with the ion exchange columns 21 for processing redox reactions in the outer conductive channel 23; and is outputted from the second opening 12. Thus, the first solution 3 processes charging by changing V⁴⁺ ions into V⁵⁺ ions; or, processes discharging by changing V⁵⁺ ions into V⁴⁺ ions. On filling the first solution 3, a second solution 4 (e.g. a V₂(SO₄)₃ solution having V³⁺ or V²⁺ ions) is directed from the third opening 13, simultaneously. The second solution channels 17 are run at the inner side of the ion exchange columns 21, which are totally separated from the first solution channels 16. When the second solution 4 is directed from the third opening 13, the second solution 4 is processed through redox reactions with coordination of the ion exchange columns 21 and the inner conductive channels 22. Then, the second solution 4 is flown out from the fourth opening 14. Thus, the V³⁺ ions in the second solution 4 are changed into V²⁺ ions for charging electricity; or, vice versa, the V²⁺ ions are changed into V³⁺ ions for discharging electricity

In the other hand, when the present invention is to be discharged, the first solution 3 and the second solution 4 are directed from the second opening 12 and the fourth opening 14 simultaneously (or separately); and the first solution 3 and the second solution 4 are flown out from the first opening 11 and the third opening 13. Thus, the present invention is discharged for working as a secondary battery through redox reactions. Hence, the present invention has the following advantages:

1. The present invention has a simple structure of without electrode plates of ditches, resulting saving production cost.

2. The present invention has a light weight for relatively increasing its weight-power density (i.e. charging density per weight unit).

2. The present invention has big surface areas of positive and negative electrodes per volume unit for increasing its volume-power density.

To sum up, the present invention is a device of charging/discharging electricity by using two flows, where a first and a second solutions are separately directed into liquid channels to be coordinated with ion exchange columns for charging/discharging electricity through redox reactions to be used as a secondary battery; and the present invention has a simple structure, a light weight, an increased volume per unit, an enhanced charging/discharging power per unit and a saved production cost.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A device of charging/discharging electricity by using two flows, comprising
a container, said container having four openings at outside to be connected into said container inside, said four openings comprising a first opening, a second opening, a third opening and a fourth opening, said container having at least two separators to separate said third opening and said fourth opening, said container obtaining two flows connecting to said first and said second openings by using said at least two separators; and
an ion-exchange conductive channel unit, said ion-exchange conductive channel unit being obtained in said container to be connected with said third opening and said fourth opening while penetrating through said separators, said ion-exchange conductive channel unit comprising a plurality of ion exchange columns, a plurality of inner conductive channels and a plurality of outer conductive channels, said inner conductive channels being obtained in said ion exchange columns, said outer conductive channels being obtained at outside of said ion exchange columns without penetrating through said separators, said inner conductive channels and said outer conductive channels coming together to be extended out of said container to obtain a first electrode and a second electrode, respectively.

2. The device according to claim 1,
wherein said two flows are two liquid solutions mutually processing electrochemical half-cell redox reactions; and
wherein said solutions contains metal ions and said metal ion is selected from a group consisting of vanadium (V) ion, chromium (Cr) ion, iron (Fe) ion, manganese (Mn) ion, cobalt (Co) ion and nickel (Ni) ion.

3. The device according to claim 1,
wherein said container has a geometric shape selected from a group consisting of a tube shape, a box shape and a polygonal shape.

4. The device according to claim 1,
wherein a first solution is obtained in said liquid channel of said container and a second solution is obtained in said ion exchange column of said ion-exchange conductive channel unit.

5. The device according to claim 1,
wherein said inner conductive channel is made of a fiber selected from a group consisting of carbon fiber, graphite fiber and metal fiber.

6. The device according to claim 1,
wherein said inner conductive channel is made of a conductive fiber bound with other non-conductive material(s) and said fiber is selected from a group consisting of carbon fiber, graphite fiber and metal fiber.

7. The device according to claim 1,
wherein said inner conductive channel is selected from a group consisting of a conductive braided tube and a conductive porous tube.

8. The device according to claim 1,
wherein said outer conductive channel is made of a fiber selected from a group consisting of carbon fiber, graphite fiber and metal fiber.

9. The device according to claim 1,
wherein said outer conductive channel is made of a fiber doped with a non-conductive material and said fiber is selected from a group consisting of carbon fiber, graphite fiber and metal fiber.

10. The device according to claim 1,
wherein said outer conductive channel is selected from a group consisting of a conductive braided tube and a conductive porous tube.

11. The device according to claim 1,
wherein said ion exchange column is a cation exchange column.

12. The device according to claim 1,
wherein said ion exchange column is an anion exchange column.

13. The device according to claim 1,
wherein said first electrode is a positive electrode and said second electrode is a negative electrode.

14. The device according to claim 1,
wherein said first electrode is a negative electrode and said second electrode is a positive electrode.
